(19) United States
(12) Patent Application Publication
(10) Pub. No.: US 2021/0117276 A1
(43) Pub. Date: Apr. 22, 2021

(54) GARBAGE COLLECTION OF UNREFERENCED DATA OBJECTS IN A PROTECTION STORE

(71) Applicant: Nuvoloso Inc., Sunnyvale, CA (US)

(72) Inventor: Michael Lee Federwisch, San Jose, CA (US)

(21) Appl. No.: 16/660,750

(22) Filed: Oct. 22, 2019

(51) Int. Cl. G06F 11/14; G06F 3/06; G06F 16/27

(52) U.S. Cl. CPC G06F 11/1451; G06F 11/1453; G06F 3/067; G06F 2201/84; G06F 3/065; G06F 16/27; G06F 3/0619; G06F 11/1464

(57) ABSTRACT

A computer-implemented method comprising: storing a plurality of existing snapshots in a protection store, wherein the particular existing snapshot is represented by a particular metadata object; removing data objects that belong to the particular existing snapshot from the protection store by: obtaining protection-store-specific hash values from the particular metadata object; based on the protection-store-specific hash values obtained from the particular metadata object, determining whether data objects that correspond to the protection-store-specific hash values obtained from the particular metadata object are being used by any other existing snapshots of the plurality of existing snapshots; in response to determining that a particular data object that corresponds to a particular protection-store-specific hash value from the particular metadata object is not used by any other existing snapshots of the plurality of existing snapshots, deleting the data object associated with the particular protection-store-specific hash value from the particular metadata object, from the protection store.

### CROSS-REFERENCE TO RELATED APPLICATIONS

This application is related to U.S. patent application Ser. No. (Attorney Docket No. 60537-0011), entitled “Data Movement Between Heterogeneous Storage Devices,” and U.S. patent application Ser. No. (Attorney Docket No. 60537-0014), entitled “Data Structure of a Protection Store for Storing Snapshots,” wherein the entire contents of which are hereby incorporated by reference as if fully set forth herein.

### TECHNICAL FIELD

The present invention relates to storage systems and, more, specifically to cross platform data management and movement.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Data is an important business asset that needs to be managed and protected. Management and manipulation of data include, but are not limited to, backup, restore, replication, migration, cascaded replication, import and export. Most data system vendors provide custom solutions that perform different parts of this process by manipulating data in proprietary ways to take advantage of unique features of their own systems. In other words, data system vendors have built proprietary replication, backup, restore and data movement solutions that move data easily between instances of their proprietary platform. However, companies often have multiple products that cover different needs for data movement. Accordingly, a major downfall of these conventional solutions is that since they take advantage of the specifics of proprietary platforms, they do not cooperate with any other platforms.

Thus, there is a need for a solution that allows data movement between storage systems of different types and architectures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an example environment in accordance with some embodiments.

FIG. 2 illustrates an example method of moving data between two data storage systems in accordance with some embodiments.

FIG. 3 illustrates an example representation of snapshots stored in a protection store in a data storage system in accordance with some embodiments.

FIG. 4A and FIG. 4B illustrate an example method of storing a snapshot in a protection store in accordance with some embodiments.

FIG. 5 illustrates an example garbage collector in accordance with some embodiments.

FIG. 6 illustrates an example method of garbage collection in accordance with some embodiments.

FIG. 7 is a block diagram that illustrates a computer system upon which an embodiment of the disclosure may be implemented.

FIG. 8 is a block diagram of a software system that may be employed for controlling the operation of computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A large part of data management of data is simply movement of data. Techniques herein are provided for generically moving data between data storage systems of different types and architectures while taking advantage of the features of the different types of storage systems. Storage systems involved can be local or remote storage systems. This movement of data is accomplished by using a protection store, which implements a data movement strategy where a central engine copies data between two endpoints interfacing with two (or more) different data storage systems.

The endpoints implement an application programming interface (API) of the protection store to treat the storage systems involved as a generic storage system entity. An endpoint implementation is needed for each type of storage system to be involved as data source or destination. The data movement strategy uses data versions (i.e., snapshots) of storage system data at different times to determine which data to move to another, different data storage system. Differences between an earlier version and a later version are determined, and only data pertaining to the differences are moved. Each endpoint translates the generic API calls into appropriate actions for the storage system it accesses. Those actions can perform, but are not limited to, deduplication, encryption, snapshots, and optimized differencing on top of the storage. The generic data representation allows for garbage collection of unreferenced data objects after a snapshot is deleted from the protection store.

### System Overview

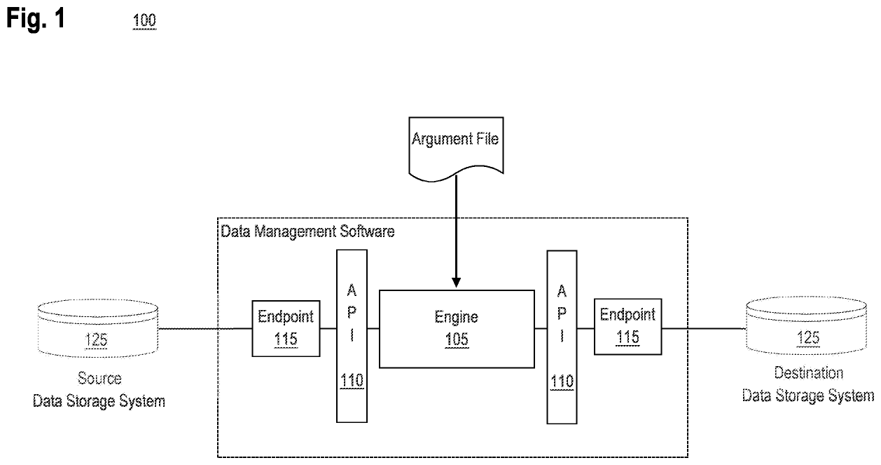

FIG. 1 illustrates an example environment in accordance with some embodiments. The environment 100 of FIG. 1 includes an endpoint management engine 105, an application programming interface (API) 110 of a protection store, and endpoints 115. The endpoint management engine 105 communicates with different endpoints 115 using the API 110. The endpoints 115 are communicatively coupled with the plurality of data storage systems 125. The plurality of data storage systems 125 may include local and/or remote data storage systems and may be of different types and architectures.

In cases where a network is needed to communicate with a remote data storage system, that network broadly represents any combination of one or more local area networks, wide area networks, campus networks and/or internetworks. Packet-switched networks may be used with networking infrastructure devices such as switches and routers that are programmed to communicate packet data based on internet protocol (IP), a transport protocol such as TCP or UDP, and higher-order protocols at any of several different logical layers, such as those defined by the Open Systems Interconnect (OSI) multi-layer internetworking model.

Each endpoint 115 hides features of an underlying data storage system 125 where data is being read from or being written to. Since the endpoint management engine 105 interacts with heterogeneous data storage systems 125 via the endpoints 115, the endpoint management engine 105 may be insulated from details of these different data storage systems 125. Data pertaining to differences or deltas in snapshots may be moved between different data storage systems 125 or within the same data storage system 125 and can be compressed and/or encrypted before being stored.

Example data storage systems include local hard disks, Nuvoloso storage systems, files, directories, and object stores, such as an Amazon S3 object store, a Microsoft Azure object store, and a Google Cloud object store. As further discussed herein, the API 110 allows developers to take advantage of different data storage systems 125 to perform deduplication, snapshots, encryption, compression, optimized differencing, and the like.

### Data Movement Between Data Storage Systems

A data management software for a data movement operation can be executed on any computing device. For example, the data management software may run on a local server, a transient server in the cloud, or serverless in the cloud. The data movement operation may include movement of data between data storage systems of same or different types and architectures. A computing device may comprise a mobile computing device, desktop computer, laptop computer, or other computing devices. The computing device is capable of receiving input via a keyboard, pointing device or other input-output device, has a visual data display device and one or more network interfaces that are capable of communication with a network. Data storage systems involved in a data movement operation may include one or more local storage systems that are directly coupled to the computing device and/or one or more remote storage systems that are coupled, via a network, to the computing device.

The data management software includes instructions implementing an endpoint management engine and endpoints. An endpoint may be provided for each type of data storage system. Slight modifications to existing endpoints of or with similar properties allow for quick implementation on future data storage system types.

In an embodiment, a developer provides the data management software input arguments. The input arguments may be provided from an argument file that includes commands and arguments that are in an organized structure that can be parsed by the endpoint management engine. An example argument file is a JavaScript Object Notation (JSON) file. Other files, such as an extensible markup language (XML) file, a “Yet Another Markup Language” (YAML) file, a MessagePack file, a Comma Separate Values (CSV) file, or the like can also be used as an argument file. Alternatively, the input arguments may be provided via an API or another suitable method. The commands and the arguments are associated with one or more API calls. Different data storage systems may implement different API calls. In some implementations, it is not necessary for each data storage system to implement all API calls. Table 1 shows example API calls.

TABLE 1

Setup(args) error
Differ(output channel, Abort func)
FetchAt(offset, hash, buffer)
FillAt(offset, hash, buf)
SkipAt(offset, hash)
GetIncrSnapName( ) string
GetLunSize( ) int64
GetSnapshotList( ) list
DeleteSnapshot(name) error
Clean(cleanArgs)
Done(success) error

Once the data management software receives the argument file, the endpoint management engine reads the argument file and parses the file for input arguments, such as commands and arguments. The arguments may include descriptions for a source data storage system, which endpoint type(s) to use, and/or descriptions for a destination data storage system. The descriptions may include security codes, access keys, bucket names, regions, and the like, for identifying and authenticating with the data storage systems. Using the input arguments, the endpoint management engine provides a source endpoint with source arguments to establish a connection with the source data storage system and provides a destination endpoint with destination arguments to establish a connection with the destination data storage system. Each endpoint sets up by using the provided arguments to communicatively couple with an underlying data storage system. In an embodiment, an endpoint is provided for each type of data storage system, and arguments are unique for each type of endpoints.

For example, a user builds or generates a JSON file that includes arguments identifying Amazon S3 as the source data storage system, along with Amazon S3 information necessary for establishing a connection with Amazon S3, and arguments identifying Nuvoloso as the destination data storage system, along with Nuvoloso information necessary for establishing a connection with Nuvoloso. The endpoint management engine reads and parses the file, and makes one or more calls to the API, providing a source endpoint with the S3 arguments parsed from the file and providing a destination endpoint with the Nuvoloso argument parsed from the file. In this example, the source endpoint includes a source endpoint type associated with Amazon S3 storage systems, and the destination endpoint includes a destination endpoint type associated with Nuvoloso storage systems.

The endpoint management engine may not understand what the arguments mean and simply passes the arguments to the endpoints. Each endpoint, however, has system specific logic to understand what it needs to do. Continuing with the example, the source endpoint instantiates an Amazon S3 object storage endpoint with the S3 arguments provided to the source endpoint, and the destination endpoint instantiates a Nuvoloso storage endpoint with the Nuvoloso arguments provided to the destination endpoint.

After the endpoints are communicatively coupled with the source data storage system and the destination data storage system, data from the source data storage system may be moved to the destination data storage system for backup, restoration, replication, migration, importation, or exportation.

Snapshots are used in the data movement operation to facilitate the movement of data. To move data between the two data storage systems, the endpoint management engine may send a Differ request for differences between a previous snapshot of a volume at the source data storage system that is taken at a previous point in time, if any, and a current snapshot of the volume at the source data storage system that is taken at the current point in time.

In response to the Differ request, the source endpoint for the source data storage system provides one or more sequential blocks of data relating to the volume, wherein each of the blocks includes an offset to data in the volume and an indication whether that block is dirty or clean. A dirty block indicates that data in the volume, at the offset, has been changed (is different) since the previous snapshot and needs to be read from the volume, while a clean block indicates that data in the volume, at the offset, has not been changed (is same) since the previous snapshot and does not need to be read from the volume.

In an embodiment, for a base or initial transfer, the source endpoint for the source data storage system may simply indicate that the entire volume, from the beginning to the end of the volume, is dirty.

In an embodiment, the granularity of the response to a Differ request is dependent on an endpoint and/or its underlying storage system. For example, the size of each block of data returned by the source endpoint may be one megabyte. Other sizes are possible. In an embodiment, if the source data storage system does not implement a snapshot differencing functionality, the Differ request for that endpoint type can return one response that says the entire source is dirty and must be copied. This ensures that all modified data is transferred to the destination data storage system. This also allows the transfer of data between more types of less functional storage systems.

For each dirty block, the endpoint management engine may send a source endpoint FetchAt request for data in the volume at the offset indicated by the dirty block. In response to the FetchAt request, the source endpoint for the source storage system reads the data in the volume at the indicated offset and returns the read data to the endpoint management engine. In an embodiment, the endpoint management engine operates on one megabyte blocks of data, but the size can vary depending on implementation. The endpoint management engine, in return, may then send a FillAt instruction, including the read data and the offset, to the destination data storage system via the destination endpoint for the destination data storage system. When all data for the dirty blocks have been requested, the endpoint management engine sends a Done notification to the source endpoint for the source data storage system to indicate that no more data needs to be read from the source data storage system.

For each clean block, the endpoint management engine may send a SkipAt notification, including an offset, to the destination data storage system via the destination endpoint for the destination data storage system. The SkipAt notification simply indicates that the data in the volume at the offset indicated by the clean block, has not changed since the previous snapshot. In an embodiment, when the data is the same as it was before, data from the previous snapshot may be used by forwarding it into the current snapshot. In another embodiment, when the data is the same as it was before, nothing further is done. When all data for the current snapshot have been written to the destination data storage system, the endpoint management engine sends a Done notification to the destination endpoint for the destination data storage system to indicate that the destination data storage system has now received all data pertaining to the current snapshot.

Although movement of data has been described as moving from one endpoint to another endpoint through the endpoint management engine, in an alternative embodiment, the endpoint management engine may send a SentTo request to the source endpoint for the source data storage system, wherein the SentTo request includes sufficient information for the source endpoint for the source data storage system to directly send all necessary data directly to the destination end point for the destination data storage system to create the current snapshot, without the endpoint management engine configured as a proxy or an intermediary between the endpoints.

Table 2 shows an example pseudo-code of endpoint management engine behavior.

TABLE 2

Startup{

Source.Setup(args)
Dest.Setup(args)
Source.GetLunInformation( )
Ch = createChannel
Worker(Ch)
Source.Differ(Ch)
Wait for Worker
Source.Done( )
Dest.Done( )

}
Work(incomingChannel) {

While (Diff = incomingChannel) {

If Diff.Dirty {

Source.FetchAt(Diff.offset)
Dest.FillAt(Diff.offset)

} else {

Dest.SkipAt(Diff.offset)

}

}

}

### Example of Moving Data

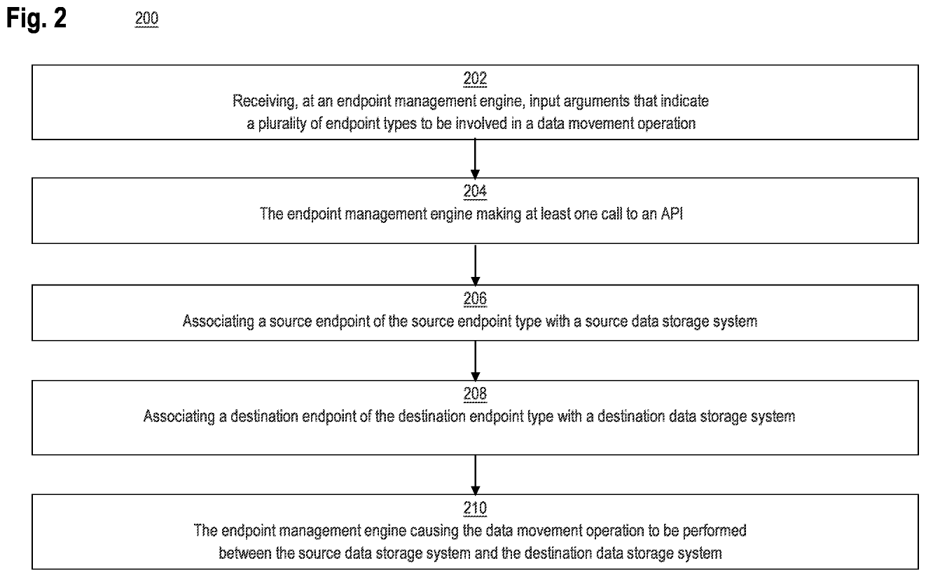

FIG. 2 illustrates an example method of moving data between two data storage systems in accordance with some embodiments. Method 200 includes operations, functions, and/or actions as illustrated by steps 202-210. For purposes of illustrating a clear example, the method of FIG. 2 is described herein with reference to execution using certain elements of FIG. 1; however, FIG. 2 may be implemented in other embodiments using computing devices, programs or other computing elements different than those of FIG. 1. Further, although the steps 202-210 are illustrated in order, the steps may also be performed in parallel, and/or in a different order than described herein. The method 200 may also include additional or fewer steps, as needed or desired. For example, the steps 202-210 can be combined into fewer steps, divided into additional steps, and/or removed based upon a desired implementation. FIG. 2 may be used as a basis to code method 200 as one or more computer programs or other software elements organized as sequences of instructions stored on computer-readable storage media. In addition, one or more of steps 202-210 may represent circuitry that is configured to perform the logical functions and operations of method 200.

At step 202, an endpoint management engine receives input arguments that indicate a plurality of endpoint types to be involved in a data movement operation. The plurality of endpoint types includes a source endpoint type associated with a first type of data storage system, and a destination endpoint type associated with a second type of data storage system.

The input arguments may be provided from an argument file, such as a JSON, an XML file, a YAML file, a MessagePack file, a CSV file, or the like. Alternatively, the input arguments may be provided via an API or another suitable method. The input arguments include all necessary commands and arguments for facilitating the data movement operation.

In response to the input arguments, at step 204, the endpoint management engine makes at least one call to an API. In an embodiment, the endpoint management engine makes the at least one call to the API using source data storage system arguments and destination data storage system arguments from the input arguments.

In response to the at least one call to the API, at step 206, a source endpoint of the source endpoint type associates with a source data storage system. In an embodiment, the source endpoint associates with the source data storage system using the source data storage system arguments. The source data storage system is the first type of data storage system.

At step 208, a destination endpoint of the destination endpoint type associates with a destination data storage system. In an embodiment, the destination endpoint associates with the destination data storage system using the destination data storage system arguments. The destination data storage system is the second type of data storage system.

The source data storage system and/or the destination data storage system may be third party data storage systems. Example data storage systems include local hard disks, Nuvoloso storage systems, files, directories, and object stores, such as an Amazon S3 object store, a Microsoft Azure object store, and a Google Cloud object store.

At step 210, the data management engine causes the data movement operation to be performed between the source data storage system and the destination data storage system.

In an embodiment, the data movement operation includes moving data that belongs to a second snapshot of the source data storage system, that does not belong to a first snapshot of the source data storage system, from the source data storage system to the destination data storage system.

The moving of the data may include determining one or more deltas between the first snapshot and the second snapshot of the source data storage system, the endpoint management engine causing a reading of the data at the source data storage system, wherein the data is associated with a particular delta of the one or more deltas, and the endpoint management engine causing a writing of the data at the destination data storage system.

In an embodiment, the data movement operation further includes indicating data that belongs to both the first snapshot and the second snapshot, to the destination data storage system. The indicating may include sending a notification to use the data that belongs to the both the first snapshot and the second snapshot, from the first snapshot.

The data movement operation may involve the endpoint management engine as a proxy or an intermediary between the source endpoint and the destination endpoint. Data received at the destination endpoint may be received from the source endpoint via the endpoint management engine. Alternatively, data received at the destination endpoint may be received directly from the source endpoint.

When all data pertaining to the second snapshot are at the destination data storage system, the destination data storage system receives a Done notification indicating that the destination data storage system has received all data pertaining to the second snapshot and that the data movement operation is now completed. The Done notification may be sent from the endpoint management engine or source endpoint to the destination endpoint.

### Data Representation of Snapshot Data

After a data movement operation is completed for a snapshot, the snapshot may be stored into a protection store in a destination data storage system. In an embodiment, the protection store is associated with a unique protection store identifier and implements a generic data format structure or representation that allows for deduplication, snapshots, encryption, compression, optimized differencing, and the like. Each snapshot that is being stored into the protection store in the destination data storage system has a corresponding metadata object that is generated and maintained by a metadata collector of an endpoint associated with the destination storage system.

The metadata object includes a list consecutive data objects belonging or pertaining to the snapshot. Data hashes may be listed multiple times in the metadata object when data is duplicated at different offsets in the snapshot. As described herein, the metadata object may be updated based on either a hash value of an incoming data object or a hash value from a metadata object associated with a previous snapshot, depending on whether an incoming data object (corresponding to a FetchAt request) or an incoming skip notification (corresponding to a SkipAt notification) is received by the endpoint associated with the destination data storage system.

When the endpoint associated with the destination data storage system receives an incoming data object pertaining to the snapshot, data-transforming functions, such as compression, encryption, and the like, may be applied to the data object, and a hash value for the data object may be computed using a hash function. In an embodiment, the hash function may be a cryptographic hash function such as a SHA-256 or SHA-512 hash function. In an embodiment, the hash function may be based on at least content of the data object and the protection store identifier, and may be further based on security information (such as one or more encryption keys). The content of the data object contains a fixed-sized data from somewhere in the snapshot that is being stored. The data object may be identified based on the computed hash value of the data object.

The endpoint associated with the destination storage system determines whether the incoming data object already exist in the protection store by comparing the hash value of the data object with other hash values of data objects that are already present in the protection store, to avoid duplication of data. If there is a match (indicating that the data object is already present in the protection store), then the data object is not stored again in the protection store. If there is no match (indicating that the data object is not yet present in the protection store), then the data object is stored in the protection store. A data object not yet present in the protection store may be because the corresponding data has changed or is new since the previous snapshot. In either case, the metadata collector updates the metadata object with information relating to the incoming data object, including the hash value of the data object and an offset indicated by the data object.

When the endpoint associated with the destination storage system receives an incoming skip notification pertaining to the snapshot, the metadata collector updates the metadata object, using an offset indicated in the skip notification, with a hash value in a metadata object corresponding to a previous snapshot. The skip notification simply indicates that the data at the offset has not been changed (is same) since the previous snapshot and, as such, the hash value in the metadata object corresponding to the previous snapshot remains the same.

When all data objects that belong to the snapshot are in the protection store, the metadata object is then stored in the protection store. A hash value of the metadata object may be computed using a hash function. In an embodiment, the hash function may be a cryptographic hash function such as a SHA-256 or SHA-512 hash function. In an embodiment, the hash function may be based on at least an identifier of the snapshot (such as snapshot name) and the protection store identifier, and may be further based on security information (such as one or more encryption keys). The metadata object may be identified based on the computed hash value of the metadata object. In an embodiment, an incoming Done notification received by the endpoint associated with the destination storage system indicates that all data objects that belong to the snapshot are already provided to the endpoint associated with the destination storage system.

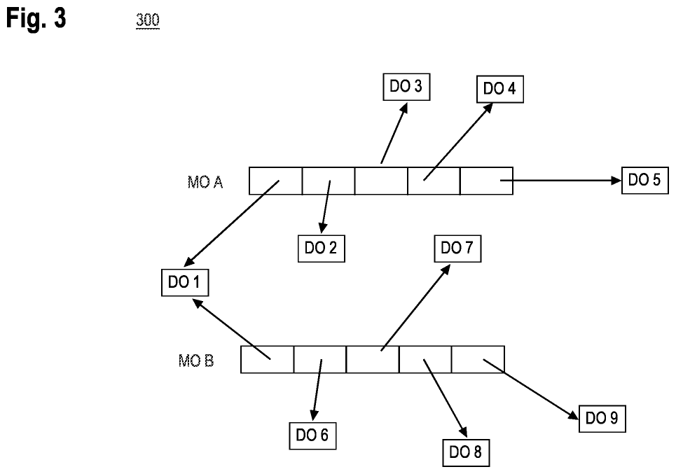

FIG. 3 illustrates an example representation of snapshots stored in a protection store in a data storage system in accordance with some embodiments. In FIG. 3, two snapshots are represented by Metadata Object A (MO A) and Metadata Object B (MO B). Metadata Object A references Data Object 1 (DO 1), Data Object 2 (DO 2), Data Object 3 (DO 3), Data Object 4 (DO 4), and Data Object 5 (DO 5) by storing protection-store-specific hash values of these data objects. Metadata Object B references Data Object 1, Data Object 6 (DO 6), Data Object 7 (DO 7), Data Object 8 (DO 8), and Data Object 9 (DO 9) by storing protection-store-specific hash values of these data objects. In this example, Metadata Object A and Metadata Object B share one data object, namely Data Object 1. Assume Metadata Object A and Data Objects 1-5 were first stored in the protection store. When Metadata Object B is created, Data Object 1 is not stored again in the protection store. However, Metadata Object B simply reference to the existing Data Object 1 by including the protection-store-specific hash value of Data Object 1 in the Metadata Object B.

To determine whether a particular snapshot exist in the protection store, a hash value is computed using at least an identifier of the particular snapshot (such as snapshot name of the particular snapshot) and the protection store identifier, and the computed hash value is compared with hash values of snapshots present in the protection store. If there is a match, then the particular snapshot is present in the protection store. The metadata object corresponding to the particular snapshot may be retrieved for further processing. If there is no match, then the particular snapshot is not present in the protection store.

### Storing Snapshot Example

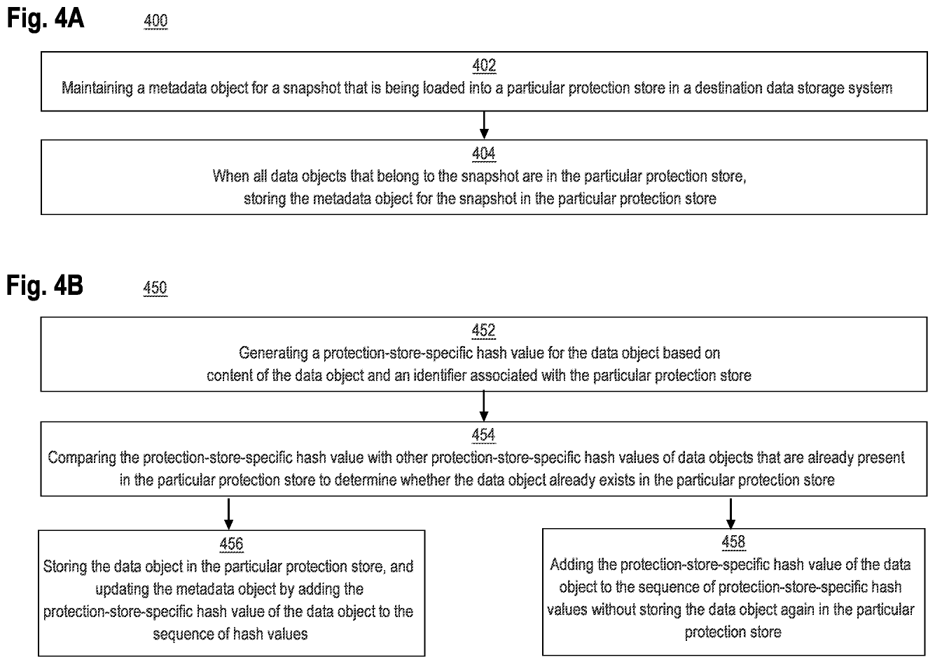

FIG. 4A and FIG. 4B illustrate an example method of storing a snapshot in a protection store in accordance with some embodiments. Methods 400 and 450 includes operations, functions, and/or actions as illustrated by steps 402, 404, and 452-458. For purposes of illustrating a clear example, the method of FIG. 4A and FIG. 4B are described herein with reference to execution using certain elements of FIG. 1; however, FIG. 4A and FIG. 4B may be implemented in other embodiments using computing devices, programs or other computing elements different than those of FIG. 1. Further, although the steps 402, 404, and 452-458 are illustrated in order, the steps may also be performed in parallel, and/or in a different order than described herein. The methods 400 and 450 may also include additional or fewer steps, as needed or desired. For example, the steps 402, 404, and 452-458 can be combined into fewer steps, divided into additional steps, and/or removed based upon a desired implementation. FIG. 4A and FIG. 4B may be used as a basis to code methods 400 and 450 as one or more computer programs or other software elements organized as sequences of instructions stored on computer-readable storage media. In addition, one or more of steps 402, 404, and 452-458 may represent circuitry that is configured to perform the logical functions and operations of methods 400 and 450.

At step 402, a metadata object is maintained for a snapshot that is being loaded into a particular protection store in a destination data storage system. In an embodiment, the metadata object is generated and maintained by a metadata collector of an endpoint associated with the destination data storage system. The endpoint may be an endpoint type that is associated with the destination data storage system. The metadata object includes a sequence of protection-store-specific hash values. Each protection-store-specific hash value of the sequence of protection-store-specific hash values corresponds to a respective data object that belongs to the snapshot.

The metadata object for the snapshot may be maintained by updating the metadata object either based on a protection-store-specific hash value for an incoming data object, or based on a protection-store-specific hash value from a metadata object associated with a previous snapshot, as illustrated in FIG. 4B.

At step 452, in response to receiving a data object that belongs to the snapshot, a protection-store-specific hash value for the data object is generated based on content of the data object and an identifier associated with the particular protection store. The content of the data object contains some data from the snapshot. The data from the snapshot may be fixed-sized or variable-sized.

At step 454, the protection-store-specific hash value is compared with other protection-store-specific hash values of data objects that are already present in the particular protection store to determine whether the data object already exists in the particular protection store.

At step 456, in response to determining that the data object does not already exist in the particular protection store, the data object is stored in the particular protection store, and the metadata object is updated by adding the protection-store-specific hash value of the data object to the sequence of hash values.

At step 458, in response to determining that the data object does already exist in the particular protection store, the protection-store-specific hash value of the data object is added to the sequence of protection-store-specific hash values without storing the data object again in the particular protection store.

During the maintenance of the metadata object, a skip notification may be received. In response to receiving a skip notification pertaining to the snapshot, a protection-store-specific hash value from a metadata object corresponding to a previous snapshot is added to the sequence of protection-store-specific hash values. The protection-store-specific hash value from the metadata object corresponding to the previous snapshot may be accessed from the metadata object corresponding to the previous snapshot by using an offset indicated in the skip notification. The skip notification indicates that the data at the offset has not been changed (is same) since the previous snapshot and, as such, the hash value in the metadata object corresponding to the previous snapshot remains the same and can be simply added to the sequence of protection-store-specific hash values.

Returning to FIG. 4A, at step 404, when all data objects that belong to the snapshot are in the particular protection store, the metadata object for the snapshot is stored in the particular protection store. An indication that all data objects that belong to the snapshot are in the particular protection store may be received at the endpoint associated with the destination data storage system. A protection-store-specific hash value for the metadata object may be generated based on an identifier associated with the snapshot and an identifier associated with the particular protection store. The metadata object for the snapshot when stored in the particular protection store may be identified using the generated hash value for the metadata object.

In an embodiment, a file containing a list of snapshots may be encrypted and stored with the name of a hash that is reliably generated from the protection store name and security information. The file contents may be encoded in JSON or XML (as described elsewhere herein). Contents of the file do not affect the name of the file, allowing consistent access to the list of snapshots. Storage of the snapshot list in the protection store is not required but some embodiments could implement this.

### PROTECTION STORE

All objects, including data objects and metadata objects, associated with one or more snapshots may be stored in a protection store at a data storage system. The protection store is associated with a unique protection store identifier. In an embodiment, the identity of the protection store is hashed and obfuscated using one or more security keys associated with the protection store, resulting in the unique identifier for the protection store.

A storage system may include a plurality of protection stores. Each of these protection stores may be associated with a different security key to prevent unauthorized access to objects stored in the protection stores. For example, two or more protection stores at one storage system may include the same objects (data objects and metadata objects). However, since objects in the protection stores are encrypted using different protection store identifiers, the same objects in these two or more protection stores do not appear the same.

In an embodiment, identities of protection stores, security keys, and/or encryption keys are provided as input arguments to the endpoint management engine to create and/or access protection stores. As discussed herein, the input arguments may be provided from an argument file, such as a JSON, an XML file, a YAML file, a MessagePack file, a CSV file, or the like.

Using the techniques described herein, data, such as a snapshot, from a first protection store may be copied to a second protection store using a different security key and/or a different encryption key. Data from the first protection store may be selected in any order to be copied to the second protection store. For example, the first protection store may thus be configured as the first backup store and the second protection store, containing the same objects as the first protection store, may be configured as the second backup store, although the same objects in these two protection stores may not appear the same.

An encryption key defines a deduplication boundary within a data storage system. An encryption key may thus expire by moving objects to a new deduplication boundary with a different encryption key. In an embodiment, deduplication only happens against objects within the same protection store since each protection store is encrypted with the same encryption key. An implementation tradeoff can be made between how fine grain encryption is and how efficient deduplication is. In particular, since protection-store-specific hash values are based on the size of the block of data being encrypted, the block size may be adjusted based on the need to do more or less deduplication.

To cleanup a protection store when one or more snapshots are deleted, garbage collection is performed for targeted cleaning to remove data objects that are associated with a deleted snapshots but are not referenced by other remaining snapshots in the protection store.

Referring again to FIG. 3, each metadata object stores protection-store-specific hash values of or otherwise references to data objects for a snapshot associated with the metadata object. In particular, Metadata Object A is associated with Snapshot A and references Data Object 1, Data Object 2, Data Object 3, Data Object 4, and Data Object 5 by storing protection-store-specific hash values of these data objects in Metadata Object A; and, Metadata Object B is associated with Snapshot B and references Data Object 1, Data Object 6, Data Object 7, Data Object 8, and Data Object 9 by storing protection-store-specific hash values of these data objects in the Metadata Object B. In this example, Metadata Object A and Metadata Object B share one data object, namely Data Object 1. Assume Snapshot A (corresponding Metadata Object A) is deleted. Garbage collection, when performed, will remove, from the protection store, unreferenced Data Object 2, Data Object 3, Data Object 4, and Data Object 5 as they are not referenced by metadata objects (Metadata Object B) corresponding with remaining snapshots (Snapshot B) in the protection store. Data object 1 is not removed as it is referenced by Metadata Object B.

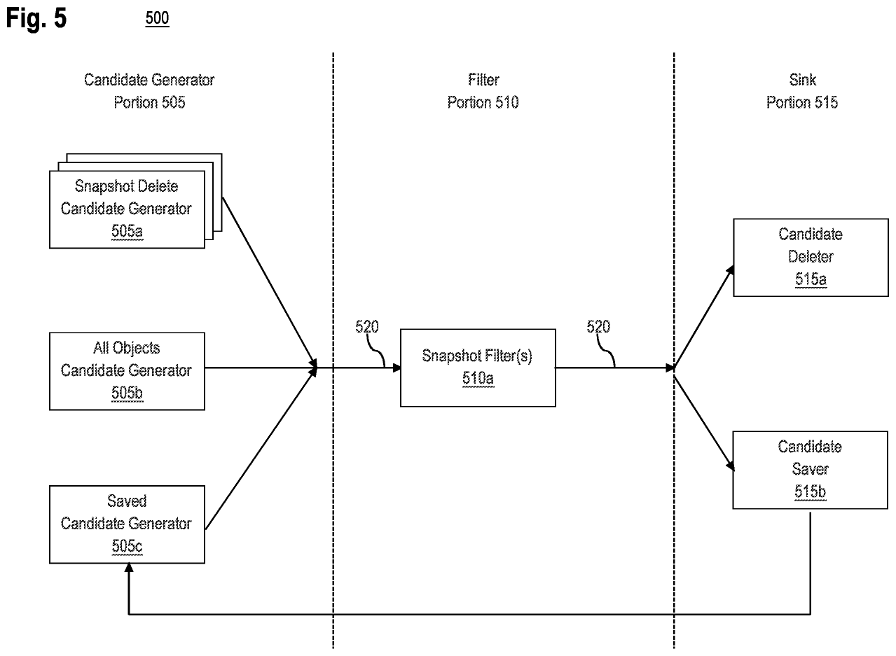

FIG. 5 illustrates an example garbage collector in accordance with some embodiments. The garbage collector 500 includes a candidate generator portion 505, a filter portion 510, and a sink portion 515.

The candidate generator portion 505 of the garbage collector 500 finds all candidates (potential data objects) for deletion and feeds them into a filter stream 520 to the filter portion 510 of the garbage collector 500. In an embodiment, there are three types of candidate generators: Snapshot Delete Candidate Generator 505a, All Objects Candidate Generator 505b, or Saved Candidate Generator 505c. A Snapshot Delete Candidate Generator 505a generates candidates of recently deleted snapshots. One or more Snapshot Delete Candidate Generators 505a may generate candidates for the same filter stream 520. The All Objects Candidate Generator 505b places all candidates into the filter stream 520 and is considered a much more complete cleaning than a Snapshot Delete Candidate Generator 505a. The Saved Candidate Generator 505c starts with the results of a previous filter and is used when more filtering is needed due to, for example, a snapshot creation.

The filter portion 510 of the garbage collector 500 receives the candidates in the filter stream 520 as inputs and outputs only those candidates that are not used by any remaining snapshots to the sink portion 515 of the garbage collector 500. In other words, the filter portion 510 only passes unreferenced objects to the sink portion 515.

At the sink portion 515 of the garbage collector 500, the unreferenced objects are either saved using a Candidate Saver 515b for further processing by the Saved Candidate Generator 505c or deleted using a Candidate Deleter 515a. The Candidate Deleter 515a deletes unreferenced objects from the protection store.

Continuing with the example that Snapshot A has been deleted from the protection store, a Snapshot Delete Candidate Generator 505a is applied to the corresponding Metadata Object A and returns all candidates associated with metadata object A. The candidates associated with Metadata Object A are Data Object 1, Data Object 2, Data Object 3, Data Object 4, and Data Object 5. In an embodiment, the protection-store-specific hashes of the data objects are returned. It may be that one or more of these candidates from the Snapshot Delete Candidate Generator 505a may still be used by other snapshots, namely Snapshot B in this example. It is noted that if multiple snapshots are deleted, then multiple Snapshot Delete Candidate Generators 505a are used to generate all potential data objects for deletion. All candidates returned from the candidate generator portion 505 are placed in the filter stream 520 to the filter portion 510 of the garbage collector 500.

At the filter portion 510 of the garbage collector 500, a Snapshot Filter 510a is applied to each remaining snapshot in the protection store. In this example, Snapshot B is a remaining snapshot in the protection store. A Snapshot Filter 510a is applied to the corresponding Metadata Object B. If a candidate is still being used by other snapshots, then the candidate is dropped, at the filter portion 510, from the filter stream 520. However, if a candidate is not being used by other snapshots, then the candidate remains in the filter stream 520 to the sink portion 515 of the garbage collector 500. Continuing with this example, Data Object 1 is dropped from the filter stream 520 since it is being used by Snapshot B. However, Data Object 2, Data Object 3, Data Object 4, and Data Object 5 remain in the filter stream 520 to the sink portion 515 of the garbage collector 500.

In an embodiment, when two or more Snapshot filters 510a are used, candidates pass through the Snapshot filters 510a sequentially. In an embodiment, multiple Snapshot filters 510a can be combined into one main Snapshot Filter, to meet a performance requirement, such as reducing the total processing time or to reduce memory consumption by the filter.

Remaining candidates that reach the sink portion 515 of the garbage collector 500 are data objects that are not used by any remaining snapshots in the protection store. In this example, Data Object 1 is dropped from the filter stream 520 by the filter portion 510 and does not reach the sink portion 515, while Data Object 2, Data Object 3, Data Object 4, and Data Object 5 remain in the filter stream 520 and reach to the sink portion 515 to be saved for further processing or to be deleted.

Garbage collection may also be performed for general house cleaning to remove all unreferenced objects (data objects) by using the All Objects Candidate Generator 505b. The All Objects Candidate Generator 505b simply puts all candidates from the protection store in the filter stream 520. At the filter portion 510 of the garbage collector 500, one or more Snapshot Filters 510a are created for the remaining snapshots. Candidates that reach the sink portion 515 are saved for further processing or are deleted.

When garbage collection is performed, a concurrency issue may arise, where another snapshot is created while garbage collection is being performed. Assume Snapshot C is created in the protection store, during garbage collection, that may use any one of the Data Object 2, Data Object 3, Data Object 4, and Data Object 5 that are in the sink portion 515. When a new snapshot is created, the data objects in the sink may be transformed, by the Candidate Saver 515b, into a temporary Metadata Object D. The Save Candidate Generator 505c is applied to Metadata Object D and a Snapshot Filter 510a is applied to Metadata Object C corresponding to Snapshot C. This process continues to repeat until the concurrency issue no longer exist. Whatever data objects that remain in the sink portion 515 are then deleted by the Candidate Deleter 515a.

### Garbage Collection Example

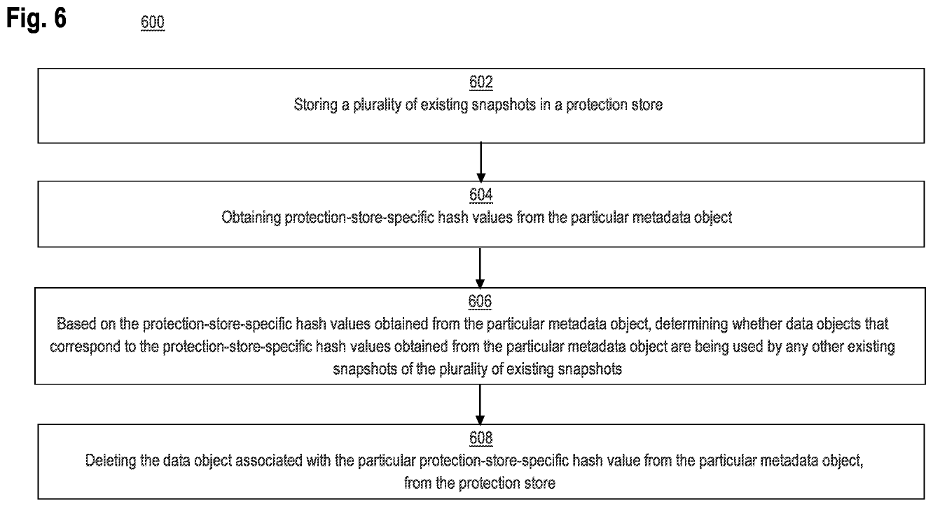

FIG. 6 illustrates an example method of garbage collection in accordance with some embodiments. Method 600 includes operations, functions, and/or actions as illustrated by steps 602-608. For purposes of illustrating a clear example, the method of FIG. 6 is described herein with reference to execution using certain elements of FIG. 1; however, FIG. 6 may be implemented in other embodiments using computing devices, programs or other computing elements different than those of FIG. 1. Further, although the steps 602-608 are illustrated in order, the steps may also be performed in parallel, and/or in a different order than described herein. The method 600 may also include additional or fewer steps, as needed or desired. For example, the steps 602-608 can be combined into fewer steps, divided into additional steps, and/or removed based upon a desired implementation. FIG. 6 may be used as a basis to code method 600 as one or more computer programs or other software elements organized as sequences of instructions stored on computer-readable storage media. In addition, one or more of steps 602-608 may represent circuitry that is configured to perform the logical functions and operations of method 600.

At step 602, a plurality of existing snapshots is stored in a protection store in a data storage system. In some embodiment, the protection store is associated with a unique identifier, as discussed herein. Each existing snapshot of the plurality of existing snapshots is represented by a respective metadata object. Each respective metadata object includes information relating to which data objects, within the protection store, belong to the snapshot represented by the respective metadata object. The plurality of existing snapshots includes a particular existing snapshot, and the particular existing snapshot is represented by a particular metadata object.

When the particular existing snapshot is deleted from the protection store, data objects that belong to the particular existing snapshot become candidates to be removed from the protection store. At step 604, protection-store-specific hash values are obtained from the particular metadata object. In an embodiment, at the candidate generator portion of the garbage collector, the Snapshot Delete Candidate Generator is applied to the particular metadata object of the deleted snapshot and generates candidates belonging to the particular existing snapshot. The candidates are data objects referenced by the particular metadata object. In an embodiment, protection-store-specific hash values corresponding to the data objects are provided to the filter portion of the garbage collector.

At step 606, based on the protection-store-specific hash values obtained from the particular metadata object, it is determined whether data objects that correspond to the protection-store-specific hash values obtained from the particular metadata object are being used by any other existing snapshots of the plurality of existing snapshots. In an embodiment, at the filter portion of the garbage collector, one or more Snapshot Filters are applied to metadata objects representative of the other existing snapshots that, at the moment, are to remain in the protection store. The obtained protection-store-specific hash values from step 602 are compared with protection-store-specific hash values in a metadata object representative of one of the any other existing snapshots.

A match indicates that the data object corresponding to the obtained protection-store-specific hash is used by the one existing snapshot, and the data object is thereby dropped from the filter portion. A no match indicates that the data object corresponding to the obtained protection-store-specific hash is not used by the one existing snapshot, and the data object is passed from the Snapshot Filter towards the sink portion of the garbage collector. If more than one Snapshot Filter is used in the filter portion, then the data object is passed from one Snapshot Filter to the next for comparison unless it is dropped from the filter portion.

At step 608, in response to determining that a particular data object that corresponds to a particular protection-store-specific hash value from the particular metadata object is not used by any other existing snapshots of the plurality of existing snapshots, the data object associated with the particular protection-store-specific hash value from the particular metadata object, is deleted from the protection store. In an embodiment, the particular data object is deleted from protection store in response to determining that no new snapshot has been created in the protection store in the meantime.

In an embodiment, in response to determining that a second particular data object that corresponds to second particular protection-store-specific hash value from the particular metadata object is not used by any other existing snapshots of the plurality of existing snapshots and to determining that a new snapshot is being created in the protection store, the second protection-store-specific hash value of the second data object is added to a temporary metadata object. In an embodiment, the temporary metadata object is created by the Candidate Saver at the sink portion of the garbage collector.

Protection-store-specific hash values from the temporary metadata object. Based on the protection-store-specific hash values obtained from the temporary metadata object, it is determined whether data objects that correspond to the protection-store-specific hash values obtained from the temporary metadata object are being used by the new snapshot. In response to determining that a particular data object that corresponds to a particular protection-store-specific hash value from the temporary metadata object is not used by the new snapshot, the data object associated with the particular protection-store-specific hash value from the temporary metadata object, is deleted from the protection store. This process continues to repeat until no concurrency issue exist.

The garbage collection operation may include simultaneously removing data objects that belong to two existing snapshot of the plurality of existing snapshots from the protection store. The garbage collection operation may also include removing all unreferenced data objects in the protection store for a general cleaning of the protection store.

### Optimizations

One or more of the following optimization techniques may be applied during data transfers to reduce the amount of data that is sent over a network.

One optimization technique is, rather than operating on one megabyte blocks of data that indicate clean or dirty, the source endpoint for the source storage system may provide to the endpoint management engine the portion(s) of each block that has been changed. The endpoint management engine would then simply fetch data relating to the modification and indicate to the destination endpoint for the destination storage system to use a corresponding hash for the previous snapshot plus the modification. A ConstructedDiff request provides location(s) within each block that has been changed. In contrast, a Differ request provides whether each block is clean or dirty.

Another optimization technique is performing deduplication of data that is sent from the source endpoint for the source storage system. For example, all data movement start out as hashes full of zeros. When a backup procedure is performed, two objects are transmitted to the destination: a metadata file, which is basically the same hash mentioned many times, and a hash full of zeroes. A whole gigabyte of data may all come down to two megabytes of data that are meaningful. A Sort call sorts all the hashes, and a Unique call brings them all down to only the sets that are unique. Read calls on the source storage system may be cached such that data corresponding to one of the hashes may be applied to different places at the destination storage system. The destination endpoint for the destination storage system adds the data to the destination and retrieves the next hash and does the same thing.

In contrast to conventional solutions that have limited interoperability, a generic data movement mechanism is provided that allows for endpoint flexibility. Techniques described herein allow for the generic data movement mechanism to be used as a primitive for all types of data movement functions including data import from other systems, data export to other systems, backup, restore, replication, and cascaded replication.

### HARDWARE Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

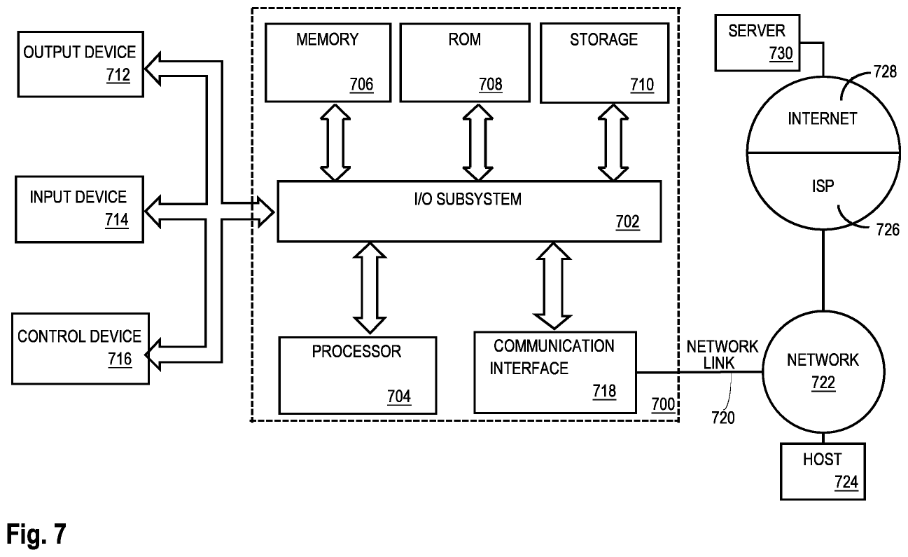

For example, FIG. 7 is a block diagram that illustrates a computer system 700 upon which an embodiment of the disclosure may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or solid-state drive is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the worldwide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

### Software Overview

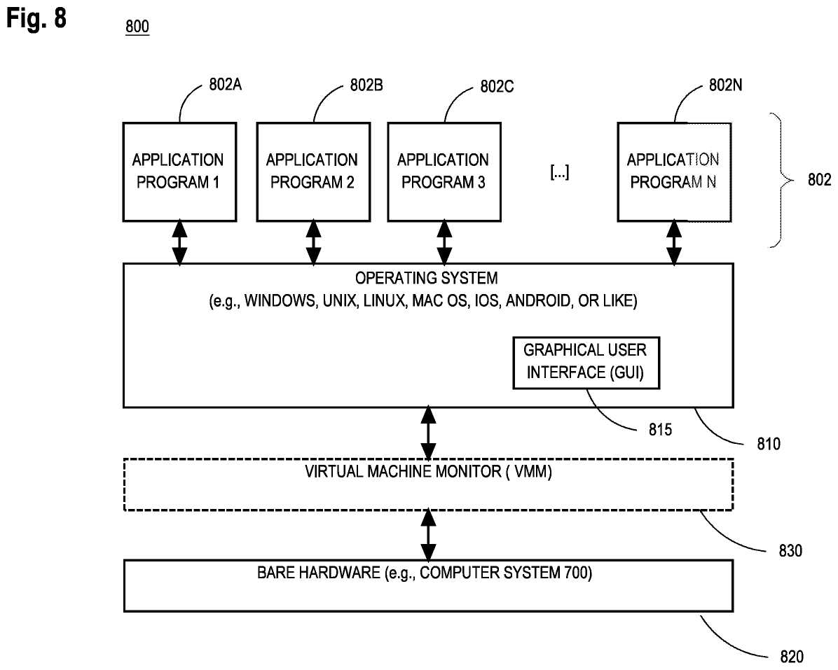

FIG. 8 is a block diagram of a software system 800 that may be employed for controlling the operation of computer system 700. Software system 800 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 800 is provided for directing the operation of computer system 700. Software system 800, which may be stored in system memory (RAM) 706 and on fixed storage (e.g., hard disk or flash memory) 710, includes a kernel or operating system (OS) 810.

The OS 810 manages low-level aspects of computer operation, including managing execution of processes, memory allocation, file input and output (I/O), and device I/O. One or more application programs, represented as 802A, 802B, 802C . . . 802N, may be “loaded” (e.g., transferred from fixed storage 410 into memory 406) for execution by the system 400. The applications or other software intended for use on system 400 may also be stored as a set of downloadable computer-executable instructions, for example, for downloading and installation from an Internet location (e.g., a Web server, an app store, or other online service).

Software system 800 includes a graphical user interface (GUI) 815, for receiving user commands and data in a graphical (e.g., “point-and-click” or “touch gesture”) fashion. These inputs, in turn, may be acted upon by the system 800 in accordance with instructions from operating system 810 and/or application(s) 802. The GUI 815 also serves to display the results of operation from the OS 810 and application(s) 802, whereupon the user may supply additional inputs or terminate the session (e.g., log off).

OS 810 can execute directly on the bare hardware 820 (e.g., processor(s) 704) of system 800. Alternatively, a hypervisor or virtual machine monitor (VMM) 830 may be interposed between the bare hardware 820 and the OS 810. In this configuration, VMM 830 acts as a software “cushion” or virtualization layer between the OS 810 and the bare hardware 820 of the system 700.

VMM 830 instantiates and runs one or more virtual machine instances (“guest machines”). Each guest machine comprises a “guest” operating system, such as OS 810, and one or more applications, such as application(s) 802, designed to execute on the guest operating system. The VMM 830 presents the guest operating systems with a virtual operating platform and manages the execution of the guest operating systems.

In some instances, the VMM 830 may allow a guest operating system to run as if it is running on the bare hardware 820 of system 700 directly. In these instances, the same version of the guest operating system configured to execute on the bare hardware 820 directly may also execute on VMM 830 without modification or reconfiguration. In other words, VMM 830 may provide full hardware and CPU virtualization to a guest operating system in some instances.

In other instances, a guest operating system may be specially designed or configured to execute on VMM 830 for efficiency. In these instances, the guest operating system is “aware” that it executes on a virtual machine monitor. In other words, VMM 830 may provide para-virtualization to a guest operating system in some instances.

The above-described basic computer hardware and software is presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Other Aspects of Disclosure

In the foregoing specification, embodiments of the invention have been described with reference to numerous specific details that may vary from implementation to implementation. Thus, the sole and exclusive indicator of what is the invention and, is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

As used herein the terms “include” and “comprise” (and variations of those terms, such as “including,” “includes,” “comprising,” “comprises,” “comprised” and the like) are intended to be inclusive and are not intended to exclude further features, components, integers or steps.

Various operations have been described using flowcharts. In certain cases, the functionality/processing of a given flowchart step may be performed in different ways to that described and/or by different systems or system modules. Furthermore, in some cases a given operation depicted by a flowchart may be divided into multiple operations and/or multiple flowchart operations may be combined into a single operation. Furthermore, in certain cases the order of operations as depicted in a flowchart and described may be able to be changed without departing from the scope of the present disclosure.

It will be understood that the embodiments disclosed and defined in this specification extends to all alternative combinations of two or more of the individual features mentioned or evident from the text or drawings. All of these different combinations constitute various alternative aspects of the embodiments.

What is claimed is:

1. A computer-implemented method comprising:
storing a plurality of existing snapshots in a protection store;
wherein each existing snapshot of the plurality of existing snapshots is represented by a respective metadata object;
wherein each respective metadata object includes information relating to which data objects, within the protection store, belong to the snapshot represented by the respective metadata object;
wherein the plurality of existing snapshots includes a particular existing snapshot;
wherein the particular existing snapshot is represented by a particular metadata object;
removing data objects that belong to the particular existing snapshot from the protection store by:
obtaining protection-store-specific hash values from the particular metadata object;
based on the protection-store-specific hash values obtained from the particular metadata object, determining whether data objects that correspond to the protection-store-specific hash values obtained from the particular metadata object are being used by any other existing snapshots of the plurality of existing snapshots;
in response to determining that a particular data object that corresponds to a particular protection-store-specific hash value from the particular metadata object is not used by any other existing snapshots of the plurality of existing snapshots, deleting the data object associated with the particular protection-store-specific hash value from the particular metadata object, from the protection store.

2. The computer-implemented method of claim 1, wherein removing data objects that belong to the particular existing snapshot from the protection store is performed in response to deleting the particular existing snapshot from the protection store.

3. The computer-implemented method of claim 1, wherein the determining whether data objects that correspond to the obtained protection-store-specific hash values are being used by any other existing snapshots of the plurality of existing snapshots, comprises comparing the obtained protection-store-specific hash values with protection-store-specific hash values in a metadata object representative of one of the any other existing snapshots.

4. The computer-implemented method of claim 1, wherein deleting the data object associated with the particular hash value is performed in response to determining that no new snapshot is being created in the protection store.

5. The computer-implemented method of claim 1, wherein the removing data objects further comprises, in response to determining that a second particular data object that corresponds to second particular protection-store-specific hash value from the particular metadata object is not used by any other existing snapshots of the plurality of existing snapshots and to determining that a new snapshot is being created in the protection store, adding the second protection-store-specific hash value of the second data object to a temporary metadata object.

6. The computer-implemented method of claim 5, wherein the removing data objects further comprises:
obtaining protection-store-specific hash values from the temporary metadata object;
based on the protection-store-specific hash values obtained from the temporary metadata object, determining whether data objects that correspond to the protection-store-specific hash values obtained from the temporary metadata object are being used by the new snapshot;
in response to determining that a particular data object that corresponds to a particular protection-store-specific hash value from the temporary metadata object is not used by the new snapshot, deleting the data object associated with the particular protection-store-specific hash value from the temporary metadata object, from the protection store.

7. The computer-implemented method of claim 1, further comprising simultaneously removing data objects that belong to two existing snapshot of the plurality of existing snapshots from the protection store.

8. The computer-implemented method of claim 1, further comprising removing all unreferenced data objects in the protection store.

9. One or more non-transitory computer-readable storage media storing one or more sequences of program instructions which, when executed by one or more computing devices, cause:
storing a plurality of existing snapshots in a protection store;
wherein each existing snapshot of the plurality of existing snapshots is represented by a respective metadata object;
wherein each respective metadata object includes information relating to which data objects, within the protection store, belong to the snapshot represented by the respective metadata object;
wherein the plurality of existing snapshots includes a particular existing snapshot;
wherein the particular existing snapshot is represented by a particular metadata object;
removing data objects that belong to the particular existing snapshot from the protection store by:
obtaining protection-store-specific hash values from the particular metadata object;
based on the protection-store-specific hash values obtained from the particular metadata object, determining whether data objects that correspond to the protection-store-specific hash values obtained from the particular metadata object are being used by any other existing snapshots of the plurality of existing snapshots;
in response to determining that a particular data object that corresponds to a particular protection-store-specific hash value from the particular metadata object is not used by any other existing snapshots of the plurality of existing snapshots, deleting the data object associated with the particular protection-store-specific hash value from the particular metadata object, from the protection store.

10. The one or more non-transitory computer-readable storage media of claim 9, wherein removing data objects that belong to the particular existing snapshot from the protection store is performed in response to deleting the particular existing snapshot from the protection store.

11. The one or more non-transitory computer-readable storage media of claim 8, wherein the determining whether data objects that correspond to the obtained protection-store-specific hash values are being used by any other existing snapshots of the plurality of existing snapshots, comprises comparing the obtained protection-store-specific hash values with protection-store-specific hash values in a metadata object representative of one of the any other existing snapshots.

12. The one or more non-transitory computer-readable storage media of claim 9, wherein deleting the data object associated with the particular hash value is performed in response to determining that no new snapshot is being created in the protection store.

13. The one or more non-transitory computer-readable storage media of claim 9, wherein the removing data objects further comprises, in response to determining that a second particular data object that corresponds to second particular protection-store-specific hash value from the particular metadata object is not used by any other existing snapshots of the plurality of existing snapshots and to determining that a new snapshot is being created in the protection store, adding the second protection-store-specific hash value of the second data object to a temporary metadata object.

14. The one or more non-transitory computer-readable storage media of claim 13, wherein the removing data objects further comprises:
obtaining protection-store-specific hash values from the temporary metadata object;
based on the protection-store-specific hash values obtained from the temporary metadata object, determining whether data objects that correspond to the protection-store-specific hash values obtained from the temporary metadata object are being used by the new snapshot;
in response to determining that a particular data object that corresponds to a particular protection-store-specific hash value from the temporary metadata object is not used by the new snapshot, deleting the data object associated with the particular protection-store-specific hash value from the temporary metadata object, from the protection store.

15. The one or more non-transitory computer-readable storage media of claim 9, wherein the one or more sequences of the program instructions which, when executed by the one or more computing devices, further cause simultaneously removing data objects that belong to two existing snapshot of the plurality of existing snapshots from the protection store.

16. The one or more non-transitory computer-readable storage media of claim 9, wherein the one or more sequences of the program instructions which, when executed by the one or more computing devices, further cause removing all unreferenced data objects in the protection store.
